(19) United States
(12) Patent Application Publication
(10) Pub. No.: US 2026/0235164 A1
(43) Pub. Date: Aug. 13, 2026

(54) DRIVING FORCE TRANSMISSION DEVICE

(71) Applicant: JTEKT CORPORATION, Kariya-shi (JP)

(72) Inventor: Koji KUBO, Kariya-shi (JP)

(73) Assignee: JTEKT CORPORATION, Kariya-shi (JP)

(21) Appl. No.: 19/474,008

(22) PCT Filed: May 1, 2023
(86) PCT No.: PCT/JP2023/017042

§ 371 Date: Oct. 9, 2025

(51) Int. Cl. F16D 1/02; F16D 1/10

(52) U.S. Cl. CPC F16D 1/02; F16D 1/10; F16D 2001/103

(57) ABSTRACT

Included are an input shaft to which rotational drive force from a drive source is input, a first joint that is linked to the input shaft, an output shaft to which the rotational drive force is output, and a second joint that is linked to the output shaft, in which a drive force transmission path includes a plurality of fitting portions that is provided with a spline shaft portion that has a plurality of spline teeth and a spline groove portion that has a plurality of fitting grooves that fits to the plurality of spline teeth, and the plurality of fitting portions includes a first fitting portion and a second fitting portion in which the plurality of spline teeth is twisted with respect to rotation axial lines, and torsional directions of the plurality of spline teeth differ between the first fitting portion and the second fitting portion.

### TECHNICAL FIELD

The present disclosure relates to a drive force transmission device.

### BACKGROUND ART

Patent Document 1 discloses a vehicle drive shaft that is one such drive force transmission device. A drive force transmission path of this vehicle drive shaft is provided with two joints and four fitting portions. Depending on the fitting, there are cases in which torsional angle is provided to spline teeth of a spline shaft to improve assembly, and to suppress rotational backlash. When torsional angle is provided to the spline teeth of the spline shaft, torsional rigidity will differ depending on the rotation direction. That is to say, in a case of a rotation direction in which the spline teeth of the spline shaft come into contact with wall faces of spline groove portions from root portions thereof, the torsional rigidity becomes relatively high. Conversely, in a case of a rotation direction in which distal end portions of the spline teeth of the spline shaft come into contact with the wall faces of the spline groove portions, the torsional rigidity is relatively low.

### RELATED ART DOCUMENTS

### Patent Documents

Patent Document 1: Japanese Unexamined Patent Application Publication No. 2020-153460 (JP 2020-153460 A)

### SUMMARY OF THE INVENTION

Now, in electric vehicles and hybrid vehicles, kinetic energy is converted into electrical energy by electric motors during regenerative braking and is recovered, and the electrical energy that is recovered is used to rotationally drive the electric motor when traveling. This allows for higher energy efficiency than in a case of braking with friction brakes (mechanical brakes). During regenerative braking, regenerative torque is generated on a drive force transmission path, but when components of the drive force transmission path have low torsional rigidity, torsional vibrations that occur when a large torque is transmitted, such as when taking off or the like, tend to be difficult to contain, which may result in poor riding comfortability of the vehicle in some cases.

To solve such problems, there is demand to increase the torsional rigidity of the components on the drive force transmission path when designing drive force transmission devices of this type. Therefore, in order to meet such demand, measures can be taken, for example, to increase the diameter of an intermediate shaft that makes up the drive force transmission path. Thus, even in a case in which the torsional rigidity differs depending on the rotation direction, such as in the vehicle drive shaft of Patent Document 1, the lower torsional rigidity can be increased. However, increasing the diameter of the intermediate shaft increases costs, which is disadvantageous with respect to a point that costs required for the drive force transmission device cannot be suppressed.

The present disclosure aims to provide a drive force transmission device that can increase the torsional rigidity without increasing the diameter of the components on the drive force transmission path.

### Means for Solving the Problem

One aspect of the present disclosure is a drive force transmission device including an input shaft to which rotational drive force from a drive source is input, a first joint that is linked to the input shaft, an output shaft to which the rotational drive force is output, a second joint that is linked to the output shaft, and an intermediate shaft connecting the first joint and the second joint, in which a drive force transmission path from the input shaft to the output shaft includes a plurality of fitting portions that is provided with a spline shaft portion that has a plurality of spline teeth and a spline groove portion that has a plurality of fitting grooves that fits to the plurality of spline teeth, and the plurality of fitting portions includes a first fitting portion and a second fitting portion in which the plurality of spline teeth is twisted with respect to the rotation axial lines, and torsional directions of the plurality of spline teeth differ between the first fitting portion and the second fitting portion.

### Effects of the Invention

In the drive force transmission device according to the above-described aspect, the plurality of fitting portions provided on the drive force transmission path from the input shaft to the output shaft includes the first fitting portion and the second fitting portion. The first fitting portion and the second fitting portion are arranged such that the torsional directions of the spline teeth of the spline shaft portion are different from each other. Accordingly, difference in torsional rigidity between the first fitting portion and the second fitting portion in accordance with the rotation direction can be cancelled out. In other words, even when the rotation direction is changed, the difference in torsional rigidity can be kept small. Also, with respect to a rotation direction in which the torsional rigidity is low, the torsional rigidity in this rotation direction can be increased. This enables decrease in torsional rigidity to be suppressed, regardless of the rotation direction. In this case, torsional vibrations that occur when a large torque is transmitted, such as when taking off or the like, are more readily suppressed, thereby improving the ride comfort of the vehicle. According to the above-described aspect, the degree to which the diameter of the components of the drive force transmission path has to be increased in order to raise the torsional rigidity can be minimized, and costs for the drive force transmission device can be suppressed accordingly.

According to the above-described aspect, a drive force transmission device can be provided in which the torsional rigidity can be raised without increasing the diameter of the components on the drive force transmission path.

Note that reference signs in parentheses in the claims represent the corresponding relations with specific means described in embodiments to be described later, and are not intended to limit the technical scope of the present disclosure.

### BRIEF DESCRIPTION OF THE DRAWINGS

The above object and other objects, features and advantages of the present disclosure will become more apparent from the following detailed description with reference to the accompanying drawings. In the drawings;

FIG. 1 is a longitudinal sectional view of a drive force transmission device according to a first embodiment;

FIG. 2 is a schematic diagram of a primary portion of a first fitting portion in FIG. 1 as viewed from an outer side in a radial direction;

FIG. 3 is a schematic diagram of a primary portion of a second fitting portion in FIG. 1 as viewed from the outer side in the radial direction;

FIG. 4 is a schematic diagram of a primary portion of a third fitting portion in FIG. 1 as viewed from the outer side in the radial direction;

FIG. 5 is a schematic diagram of a primary portion of a fourth fitting portion in FIG. 1 as viewed from the outer side in the radial direction;

FIG. 6 is a schematic diagram illustrating the first fitting portion in FIG. 2 in a state in which a spline shaft portion rotates in a first rotation direction;

FIG. 7 is a schematic diagram illustrating the second fitting portion in FIG. 3 in a state in which the spline shaft portion rotates in the first rotation direction;

FIG. 8 is a schematic diagram illustrating the first fitting portion in FIG. 2 in a state in which the spline shaft portion rotates in a second rotation direction;

FIG. 9 is a schematic diagram illustrating the second fitting portion in FIG. 3 in a state in which the spline shaft portion rotates in the second rotation direction; and

FIG. 10 is a diagram for describing a comparison of torsional rigidity of each of the first embodiment and a comparative example.

### MODES FOR CARRYING OUT THE INVENTION

Hereinafter, a drive force transmission device according to one embodiment of the above aspect will be described with reference to the drawings.

### First Embodiment

### 1. Overall Structure of Drive Force Transmission Device 1

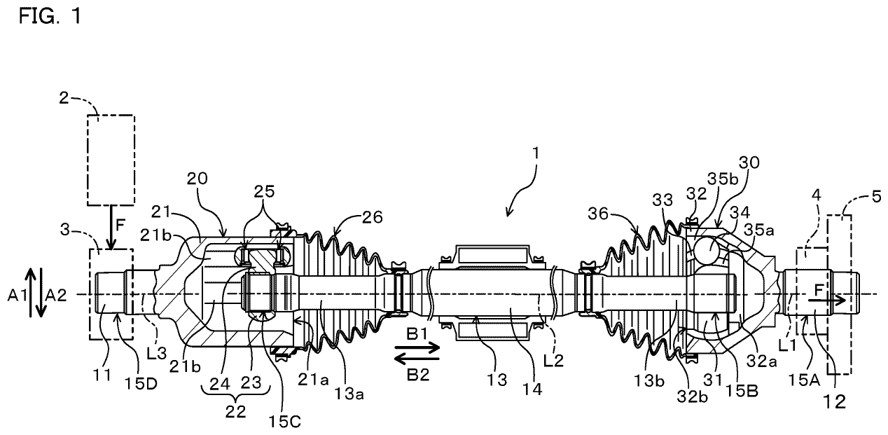

A drive force transmission device 1 according to a first embodiment illustrated in FIG. 1 corresponds to a vehicle drive shaft. This drive force transmission device 1 includes an input shaft 11, an output shaft 12, an intermediate shaft 13, a first joint 20, and a second joint 30.

A rotational drive force F from a drive source 2 is input to the input shaft 11 via a differential mechanism 3. The input shaft 11 is linked to a differential mechanism 3, which is an input side member, and a fourth fitting portion 15D is provided at this connection portion. Also, the input shaft 11 is linked to the first joint 20. Note that in the present embodiment, the drive source 2 is an electric motor.

The rotational drive force F from the drive source 2 is output to the output shaft 12. This output shaft 12 is linked to a hub bearing 4, which is an output side member that rotates integrally with drive wheels 5, and a first fitting portion 15A is provided at this linking portion. Also, this output shaft 12 is linked to the second joint 30. The intermediate shaft 13 is provided to connect the first joint 20 and the second joint 30. A third fitting portion 15C is provided at a linking portion between the first joint 20 and one end portion 13a of the intermediate shaft 13 (left end portion in FIG. 1). A second fitting portion 15B is provided at a linking portion between the second joint 30 and another end portion 13b of the intermediate shaft 13 (right end portion in FIG. 1).

The input shaft 11 is provided on a rotation axial line L3. The output shaft 12 is provided on a rotation axial line L1. The intermediate shaft 13 is provided on a rotation axial line L2. A drive force transmission path 14 between the input shaft 11 and the output shaft 12 is provided with four fitting portions 15A, 15B, 15C, and 15D. In the present embodiment, one each (i.e., the same number) of the first fitting portion 15A and the second fitting portion 15B are provided.

As illustrated in FIG. 1, in the present embodiment, a forward rotation direction in which the input shaft 11, the intermediate shaft 13, and the output shaft 12, all rotate about their respective rotation axial lines, when the vehicle travels forward, is defined as a first rotation direction A1. Also, a reverse rotation direction when the vehicle travels backward is defined as a second rotation direction A2. Also, a transmission direction in which the rotational drive force F and drive torque from the drive source 2 are transmitted through the intermediate shaft 13 is indicated by an arrow B1, and a transmission direction in which regenerative torque is transmitted through the intermediate shaft 13 is indicated by an arrow B2.

### 1-1. Structure of First Joint 20

As illustrated in FIG. 1, the first joint 20 is an inboard joint that is provided on the input shaft 11 side. This first joint 20 is referred to as a tripod type constant-velocity joint. This first joint 20 includes an outer ring 21, a tripod 22, and three roller units 25.

The outer ring 21 is formed in a bottomed cylindrical shape having an opening portion 21a at one end side (right side in FIG. 1) in an axial direction along the rotation axial line L3. On an inner peripheral face of the outer ring 21, three raceway grooves 21b are formed at equal intervals in a circumferential direction, extending in the axial direction from the opening portion 21a of the outer ring 21 toward the far side (left side in FIG. 1).

The tripod 22 is movable in the axial direction, and is also tiltable, with respect to the outer ring 21. This tripod 22 includes a boss 23 to which the one end portion 13a of the intermediate shaft 13 is linked, and three tripod shaft portions 24 extending outward in a radial direction from the boss 23. An outer peripheral face of each of the tripod-shaft portions 24 is formed as a spherical convex shape. That is to say, axial direction sectional shapes of the outer circumferential faces of the tripod-shaft portions 24 are formed as arcuate convex shapes.

The roller units 25 are formed as annular shapes. The roller units 25 are rotatable on an outer peripheral side of each of the three tripod-shaft portions 24, are slidable in axial directions of each of the three tripod-shaft portions 24, and are also supported so as to be tiltable relative to each of the three tripod-shaft portions 24. Further, the three roller units 25 are each disposed so as to be rollable along each of the three raceway grooves 21b. Accordingly, the three roller units 25 are configured to roll in a state in which orientations thereof are maintained relative to the three raceway grooves 21b.

A boot 26 is provided on the opening portion 21a side of the outer ring 21. The boot 26 is formed in a shape of an accordion tube that expandable and contractible in the axial direction and is also bendable. This boot 26 functions to seal grease that is contained in an inside region of the outer ring 21 so as to be kept from leaking out, by closing the opening portion 21a side of the outer ring 21.

### 1-2. Structure of Second Joint 30

As illustrated in FIG. 1, the second joint 30 is an outboard joint that is provided on the output shaft 12 side. This second joint 30 is what is referred to as a ball type constant-velocity joint. For example, a Rzeppa type fixed constant-velocity joint, or the like, is used. This second joint 30 includes an inner ring 31 to which the other end portion 13b of the intermediate shaft 13 is linked, and an outer ring 32 having an accommodation chamber 32a that is formed therein. The inner ring 31 is accommodated in the accommodation chamber 32a of the outer ring 32. The outer ring 32 is formed as a bottomed cylindrical shape having an opening portion 32b at one end side (left side in FIG. 1) in the axial direction along the rotation axial line L1.

Between the inner ring 31 and the outer ring 32 of the second joint 30, a cage 33 that is substantially cylindrical, and a plurality of balls 34, are provided. The plurality of balls 34 is held in a plurality of holding holes formed in the cage 33. An outer peripheral face of the inner ring 31 is provided with a plurality of guide grooves 35a corresponding to the plurality of balls 34, and an inner peripheral face of the outer ring 32 is provided with a plurality of guide grooves 35b corresponding to the plurality of balls 34. The plurality of balls 34 is guided in a state of being fitted into the guide grooves 35a and 35b of the inner ring 31 and the outer ring 32. This allows the outer ring 32 to move in an arc within a predetermined range with the other end portion 13b of the intermediate shaft 13 as a starting point.

A boot 36 is provided on the opening portion 32b side of the outer ring 32. The boot 36 is formed in a shape of an accordion tube that expandable and contractible in the axial direction and is also bendable. This boot 36 functions to seal grease contained in an inside region of the outer ring 32 so as to be kept from leaking out, by closing the opening portion 32b side of the outer ring 32.

Note that for further detailed structures of the first joint 20 and the second joint 30 of the drive force transmission device 1 described above, the structure of the vehicle drive shaft 10 described in JP 2020-153460 A, for example, can be referenced.

### 1-3. Structure of First Fitting Portion 15A

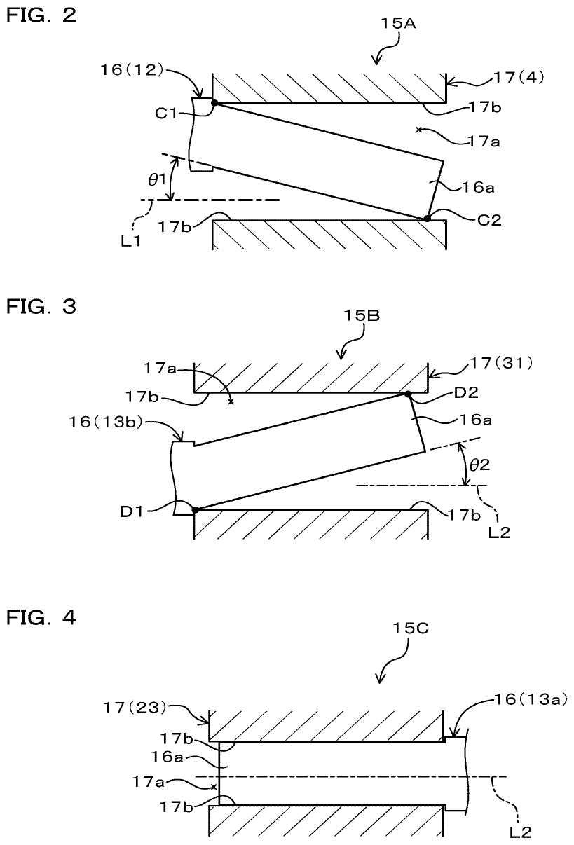

As illustrated in FIG. 2, the first fitting portion 15A is one of the four fitting portions 15A, 15B, 15C, and 15D. This first fitting portion 15A has a spline shaft portion 16 and a spline groove portion 17.

In the first fitting portion 15A, the spline shaft portion 16 is provided on the output shaft 12 (see FIG. 1) and has a plurality of spline teeth 16a. The plurality of spline teeth 16a protrudes outward in the radial direction from an outer surface of the output shaft 12 and is disposed at intervals around the circumferential direction of the output shaft 12. The plurality of spline teeth 16a has the same torsional direction, and is also twisted at the same torsional angle θ1 with respect to the rotation axial line L1.

In the first fitting portion 15A, the spline groove portion 17 is provided in the hub bearing 4 (see FIG. 1) and has a plurality of fitting grooves 17a that is fit with the plurality of spline teeth 16a of the spline shaft portion 16 by press-fitting. In this first fitting portion 15A, in a state in which the spline shaft portion 16 is assembled to the spline groove portion 17, each of the spline teeth 16a comes into contact with wall faces 17b of the spline groove portion 17 at both a root side contact point Cl and a distal end side contact point C2.

### 1-4. Structure of Second Fitting Portion 15B

As illustrated in FIG. 3, the second fitting portion 15B is one of the four fitting portions 15A, 15B, 15C, and 15D. The second fitting portion 15B includes a spline shaft portion 16 and a spline groove portion 17, similar to the case of the first fitting portion 15A.

In the second fitting portion 15B, the spline shaft portion 16 is provided on the other end portion 13b (see FIG. 1) of the intermediate shaft 13, and has a plurality of the spline teeth 16a. The plurality of the spline teeth 16a protrudes outward in the radial direction from an outer surface of the other end portion 13b of the intermediate shaft 13 and are disposed at intervals around the circumferential direction of the intermediate shaft 13. The plurality of spline teeth 16a has the same torsional direction, and is also twisted at the same torsional angle θ1 with respect to the rotation axial line L2. The plurality of spline teeth 16a has the same torsional direction, and is also twisted at the same torsional angle θ2 with respect to the rotation axial line L2.

In the second fitting portion 15B, the spline groove portion 17 is provided in the inner ring 31 (see FIG. 1) of the second joint 30, and has a plurality of fitting grooves 17a that is fit with the plurality of spline teeth 16a of the spline shaft portion 16 by press-fitting. In this second fitting portion 15B, in a state in which the spline shaft portion 16 is assembled to the spline groove portion 17, each of the spline teeth 16a comes into contact with wall faces 17b of the spline groove portion 17 at both a root side contact point D1 and a distal end side contact point D2.

As illustrated in FIG. 2 and FIG. 3, in the present embodiment, the torsional direction of the spline teeth 16a of the spline shaft portion 16 is different from that of the first fitting portion 15A and the second fitting portion 15B. That is to say, in FIG. 2 and FIG. 3, with the direction in which each rotation axial line extends as a right-left direction, the spline teeth 16a of the first fitting portion 15A extend downward to the right from the root side thereof toward the distal end side thereof. In contrast, the spline teeth 16a of the second fitting portion 15B extend upward to the right from the root side thereof toward the distal end side thereof. That is to say, when a direction orthogonal to the rotation axial line is taken as an up-down direction, the spline teeth 16a of the second fitting portion 15B are disposed so as to be inverted in the up-down direction as compared to the spline teeth 16a of the first fitting portion 15A.

### 1-5. Structure of Third Fitting Portion 15C

As illustrated in FIG. 4, the third fitting portion 15C is one of the four fitting portions 15A, 15B, 15C, and 15D. This third fitting portion 15C includes a spline shaft portion 16 and a spline groove portion 17, similar to the case of the first fitting portion 15A.

In the third fitting portion 15C, the spline shaft portion 16 is provided on one end portion 13a (see FIG. 1) of the intermediate shaft 13, and has a plurality of spline teeth 16a. The plurality of spline teeth 16a is configured to protrude outward in the radial direction from an outer surface of one end portion 13a of the intermediate shaft 13. However, unlike those of the first fitting portion 15A, the plurality of spline teeth 16a extends linearly along the rotation axial line L2. In this third fitting portion 15C, the spline groove portion 17 is provided in the boss 23 (see FIG. 1) of the tripod 22 of the first joint 20, and has a plurality of fitting grooves 17a that is fit with the plurality of spline teeth 16a of the spline shaft portion 16 by press-fitting. In this third fitting portion 15C, in a state in which the spline shaft portion 16 is assembled to the spline groove portion 17, each of the spline teeth 16a comes into contact with wall faces 17b of the spline groove portion 17 on both faces in the rotation direction thereof.

### 1-6. Structure of Fourth Fitting Portion 15D

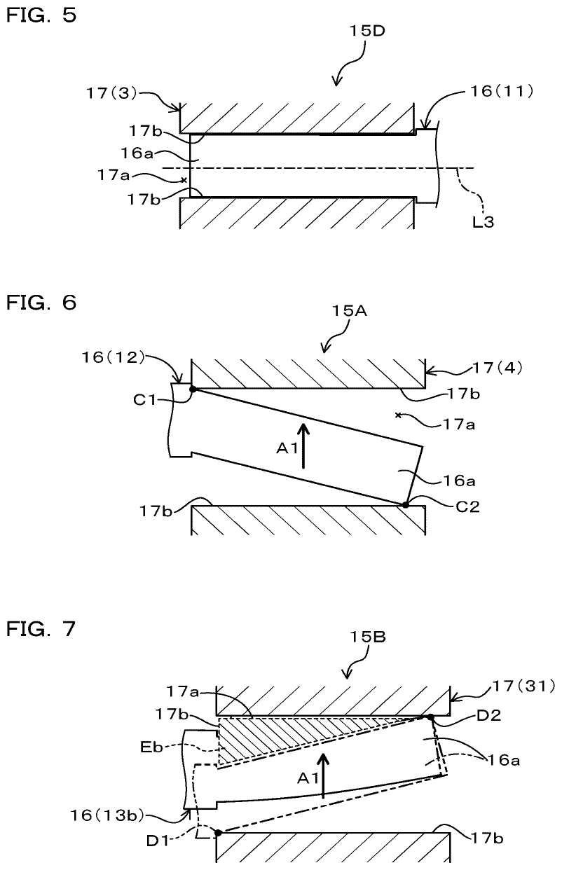

As illustrated in FIG. 5, the fourth fitting portion 15D is one of the four fitting portions 15A, 15B, 15C, and 15D. This fourth fitting portion 15D includes a spline shaft portion 16 and a spline groove portion 17, similar to the case of the first fitting portion 15A.

In the fourth fitting portion 15D, the spline shaft portion 16 is provided on the input shaft 11 (see FIG. 1) and has a plurality of spline teeth 16a. The plurality of spline teeth 16a is configured to protrude outward in the radial direction from an outer surface of the input shaft 11. The plurality of spline teeth 16a extends linearly along the rotation axial line L3, in the same way as with those of the third fitting portion 15C. In this fourth fitting portion 15D, the spline groove portion 17 is provided in the differential mechanism 3 (see FIG. 1), and has a plurality of fitting grooves 17a that is fit with the plurality of spline teeth 16a of the spline shaft portion 16 by press-fitting. In this fourth fitting portion 15D, in a state in which the spline shaft portion 16 is assembled to the spline groove portion 17, each of the spline teeth 16a comes into contact with wall faces 17b of the spline groove portion 17 on both faces in the rotation direction thereof.

### 2. Operations of Fitting Portions 15A and 15B

Next, operations of the fitting portions 15A and 15B having the above configuration will be described.

### 2-1. Regarding First Rotation Direction A1

As illustrated in FIG. 6, in the first fitting portion 15A, when the spline shaft portion 16 rotates in the first rotation direction Al, each of the spline teeth 16a is hardly deformed at all, and maintains a state close to the initial state of being in contact with the wall faces 17b of the spline groove portion 17 at both the root side contact point C1 and the distal end side contact point C2. This is because there is little region on a front side in the first rotation direction A1 where each of the spline teeth 16a can deform.

In contrast, as illustrated in FIG. 7, in the second fitting portion 15B, a deformation allowance region Eb (substantially triangular region that is indicated by dashed lines in FIG. 7) of each of the spline teeth 16a is present on the front side in the first rotation direction A1. Accordingly, in the second fitting portion 15B, when the spline shaft portion 16 rotates in the first rotation direction A1, each of the spline teeth 16a can deform from the initial state indicated by long dashed double-short dashed lines to, for example, a state indicated by a continuous line, with the distal end side contact point D2 as a fulcrum. At this time, each of the spline teeth 16a is released from contact with the wall faces 17b at the root side contact point D1. Accordingly, in comparison with the first fitting portion 15A, the second fitting portion 15B has a greater deformation amount in the first rotation direction A1, and a lower torsional rigidity.

### 2-2. Regarding Second Rotation Direction A2

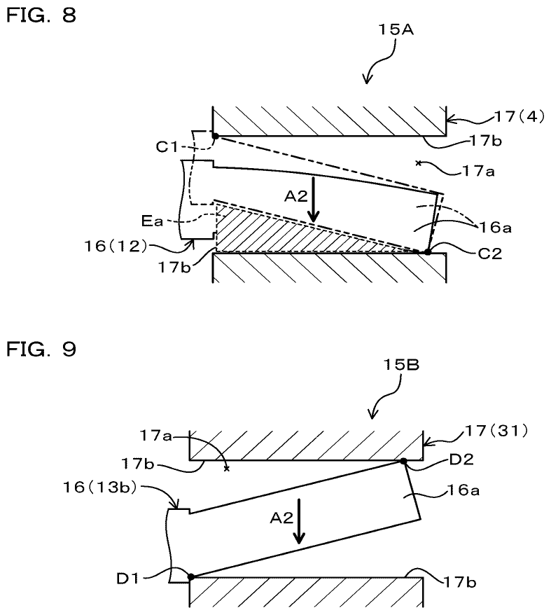

As illustrated in FIG. 8, in the first fitting portion 15A, a deformation allowance region Ea (substantially triangular region indicated by dashed lines in FIG. 8) of each of the spline teeth 16a is present on a front side in the second rotation direction A2. Accordingly, in the first fitting portion 15A, when the spline shaft portion 16 rotates in the second rotation direction A2, each of the spline teeth 16a can deform from the initial state indicated by long dashed double-short dashed lines to, for example, a state indicated by a continuous line, with the distal end side contact point C2 as a fulcrum. At this time, each of the spline teeth 16a is released from contact with the wall faces 17b at the root side contact point C1.

In contrast, as illustrated in FIG. 9, in the second fitting portion 15B, when the spline shaft portion 16 rotates in the second rotation direction A2, each of the spline teeth 16a is hardly deformed at all, and maintains a state close to the initial state of being in contact with the wall faces 17b of the spline groove portion 17 at both the root side contact point D1 and the distal end side contact point D2. This is because there is little region on the front side in the second rotation direction A2 where each of the spline teeth 16a can deform. Accordingly, in comparison with the first fitting portion 15A, the second fitting portion 15B has a smaller deformation amount in the second rotation direction A2 and a higher torsional rigidity.

Note that in the present embodiment, the torsional angle θ1 of the spline teeth 16a of the first fitting portion 15A may be the same as the torsional angle θ2 of the spline teeth 16a of the second fitting portion 15B, or may be different from the torsional angle θ2. Making the torsional angle θ1 and the torsional angle θ2 to be equal to each other, enables difference in torsional rigidity to be reduced when the rotation direction is switched. On the other hand, making the torsional angle θ1 and the torsional angle θ2 to be different enables design to be made in which difference in torsional rigidity is provided, in accordance with the difference in the rotation direction.

Also, in this form, the product of the torsional angle θ1 and the fitting length of the spline teeth 16a of the first fitting portion 15A can be made to agree with the product of the torsional angle θ2 and the fitting length of the spline teeth 16a of the second fitting portion 15B. The term fitting length of the spline teeth 16a as used here means the dimension in a press-fitting direction of the fitting portion of the spline teeth 16a press-fitted into the fitting grooves 17a, that is actually fitted into the fitting grooves 17a. Thus, the deformation allowance region Ea (see FIG. 8) for the spline teeth 16a of the first fitting portion 15A and the deformation allowance region Eb (see FIG. 7) for the spline teeth 16a of the second fitting portion 15B become the same size. Accordingly, the amount of deformation of the spline teeth 16a that are more deformed can be made to be substantially the same between the first fitting portion 15A and the second fitting portion 15B, regardless of the rotation direction.

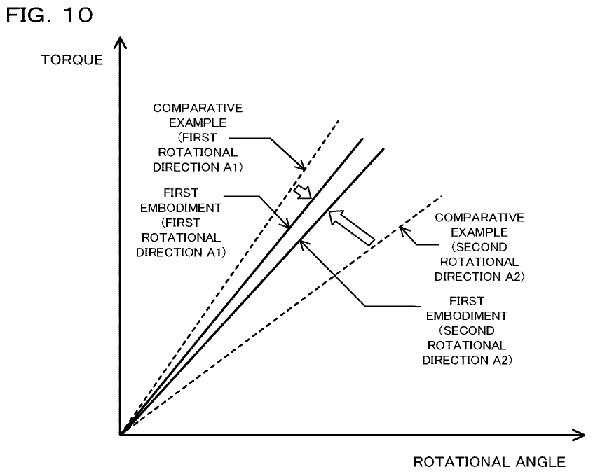

Now, the torsional rigidity in each of the first embodiment and the comparative example will be compared regarding the first rotation direction and the second rotation direction, with reference to FIG. 10. The torsional rigidity is expressed as a correlation between the torque and the rotation angle of the spline shaft portion 16, as shown in FIG. 10.

Note that the structure of the comparative example is based on the assumption of a case in which the torsional direction of each of the spline teeth 16a of the spline shaft portion 16 of each of the two fitting portions 15A and 15B is the direction illustrated in FIG. 2. Accordingly, the spline teeth 16a of both of the two fitting portions 15A and 15B of the comparative example also operate in the same manner as described using FIG. 6 with respect to the first rotation direction A1, while operating in the same manner as described using FIG. 8 with respect to the second rotation direction A2.

In the case of the comparative example, the deformation amounts of each of the spline teeth 16a of the two fitting portions 15A and 15B in the first rotation direction A1 are both slight (see FIG. 6). In contrast, in the case of the first embodiment, the amount of deformation of each of the spline teeth 16a of the first fitting portion 15A in the first rotation direction A1 is slight (see FIG. 6), but the amount of deformation of each of the spline teeth 16a of the second fitting portion 15B in the first rotation direction A1 is great (see FIG. 7). For this reason, with respect to the first rotation direction A1, the torque in the comparative example exceeds that in the first embodiment at the same rotation angle.

In the case of the comparative example, the deformation amounts of each of the spline teeth 16a of the two fitting portions 15A and 15B in the second rotation direction A2 are both great (see FIG. 8). In contrast, in the case of the first embodiment, the amount of deformation of each of the spline teeth 16a of the first fitting portion 15A in the second rotation direction A2 is great (see FIG. 8), but the amount of deformation of each of the spline teeth 16a of the second fitting portion 15B in the second rotation direction A2 is slight (see FIG. 9). With respect to the second rotation direction A2, the torque in the first embodiment exceeds that in the comparative example at the same rotation angle. That is to say, in a case in which the structure of the first embodiment is adopted, a value of the torsional rigidity can be raised for the reverse traveling side of the vehicle in the comparative example. In this case, difference between the torsional rigidity on the forward traveling side of the vehicle and the torsional rigidity on the reverse traveling side of the vehicle is smaller than in the comparative example.

### 3. Effects and Advantages

Next, effects and advantages of the above-described first embodiment will be described.

In the drive force transmission device 1 according to the first embodiment, the plurality of fitting portions provided on the drive force transmission path 14 between the input shaft 11 and the output shaft 12 includes the first fitting portion 15A and the second fitting portion 15B. The first fitting portion 15A and the second fitting portion 15B are configured such that the torsional directions of the spline teeth 16a of the spline shaft portion 16 are different from each other. Accordingly, the difference in torsional rigidity between the first fitting portion 15A and the second fitting portion 15B due to the rotation direction can be cancelled out. In other words, even when the rotation direction is changed, the difference in torsional rigidity can be kept small. Also, with respect to a rotation direction in which the torsional rigidity is low, the torsional rigidity in this rotation direction can be increased. This enables decrease in torsional rigidity to be suppressed, regardless of the rotation direction. In particular, providing the same number of the first fitting portion 15A and the second fitting portion 15B enables this effect to be enhanced. In this case, in this case, torsional vibrations that occur when a large torque is transmitted, such as when taking off or the like, are more readily suppressed, thereby improving the ride comfort of the vehicle. According to the first embodiment, the degree to which the diameter of the components of the drive force transmission path 14 (e.g., intermediate shaft 13) has to be increased in order to raise the torsional rigidity can be minimized, and costs for the drive force transmission device 1 can be suppressed accordingly.

According to the first embodiment, the drive force transmission device 1, in which torsional rigidity can be raised without increasing the diameter of components of the drive force transmission path 14, can be provided.

Although the present disclosure has been described in accordance with the above-described form, it is understood that the present disclosure is not limited to such forms and structures. The present disclosure also encompasses various modifications and variations within the scope of equivalents. Additionally, various combinations and forms, as well as other combinations and forms that include only one element, more than this, or less than this, fall within the scope and spirit of the present disclosure.

In the above-described embodiment, an example is given of a case in which one first fitting portion 15A and one second fitting portion 15B are provided on the drive force transmission path 14, but the number of first fitting portions 15A and the number of second fitting portions 15B are not limited to one and can be changed appropriately as necessary. In this case, the first fitting portion 15A and the second fitting portion 15B may be plural and also the same in number, or the number of the first fitting portion 15A may be different from the number of the second fitting portion 15B. Also, the structure of the third fitting portion 15C may be changed to that of the first fitting portion 15A, and the structure of the fourth fitting portion 15D may be changed to that of the second fitting portion 15B, as necessary.

In the form described above, a case is exemplified in which the drive force transmission path 14 is provided with the four fitting portions 15A, 15B, 15C, and 15D, but other fitting portions may be added as necessary.

1-5. (canceled)

6. A drive force transmission device comprising:
an input shaft to which rotational drive force from a drive source is input;
a first joint that is linked to the input shaft;
an output shaft to which the rotational drive force is output;
a second joint that is linked to the output shaft;
and an intermediate shaft connecting the first joint and the second joint, wherein
a drive force transmission path from the input shaft to the output shaft includes a plurality of fitting portions that is provided with a spline shaft portion that has a plurality of spline teeth and a spline groove portion that has a plurality of fitting grooves that fits to the plurality of spline teeth, and
the plurality of fitting portions includes a first fitting portion and a second fitting portion in which the plurality of spline teeth is twisted with respect to rotation axial lines, and torsional directions of the plurality of spline teeth differ between the first fitting portion and the second fitting portion.

7. The drive force transmission device according to claim 6, wherein the same number of the first fitting portion and the second fitting portion are provided.

8. The drive force transmission device according to claim 6, wherein the first fitting portion is provided at a linking portion of the output shaft and an output side member, and the second fitting portion is provided at a linking portion of the second joint and the intermediate shaft.

9. The drive force transmission device according to claim 6, wherein the plurality of fitting portions includes a third fitting portion that is provided at a linking portion of the input shaft and an input side member, and a fourth fitting portion that is provided at a linking portion of the first joint and the intermediate shaft, and in the third fitting portion and the fourth fitting portion, the plurality of spline teeth extends linearly along rotation axial lines.

10. The drive force transmission device according to claim 6, wherein the first joint is a tripod type constant-velocity joint, and the second joint is a ball type constant-velocity joint.

11. The drive force transmission device according to claim 6, wherein the plurality of spline teeth extends in a torsional direction that is downward and to right or upward and to the right with a direction in which the rotation axial lines extend as a right-left direction, such that in a case in which the torsional direction is downward and to the right at the first fitting portion, the torsional direction is upward and to the right at the second fitting portion, and in a case in which the torsional direction is upward and to the right at the first fitting portion, the torsional direction is downward and to the right at the second fitting portion.
